(19) United States
(12) Patent Application Publication
(10) Pub. No.: US 2017/0263208 A1
(43) Pub. Date: Sep. 14, 2017

(54) METHOD AND APPARATUS FOR DYNAMICALLY CONTROLLING PRIVACY OF A DISPLAY SCREEN

(71) Applicant: LENOVO (SINGAPORE) PTE. LTD., New Tech Park (SG)

(72) Inventors: Takumi IMAI, New Tech Park (SG); Markus Takashi HEBERLEIN, New Tech Park (SG); Joel W. COLLINS, New Tech Park (SG); Hiroyuki SUMI, New Tech Park (SG)

(73) Assignee: LENOVO (SINGAPORE) PTE. LTD., New Tech Park (SG)

(21) Appl. No.: 15/066,097

(22) Filed: Mar. 10, 2016

(51) Int. Cl. G09G 5/10; G06F 3/0484; G09G 5/373; G09G 5/30; G09G 5/38

(52) U.S. Cl. CPC G09G 5/10; G09G 5/30; G09G 5/38; G09G 5/373; G06F 3/04847; G09G 2320/068; G09G 2320/0626; G09G 2320/0606; G09G 2354/00

(57) ABSTRACT

A user device having dynamic control of the privacy and brightness of a display sof a user device is described. The user device includes a processor that obtains information indicating whether a change to the brightness and/or viewing angle of the display is desired. In response to instructions from the processor requesting a change to the brightness and/or privacy of the display, a controller connected to the processor increases or decreases the display brightness and/or viewing angle by controlling a backlight included in the display.

### FIELD OF INVENTION

The present disclosure generally relates to dynamically controlling privacy of the display screen of a user device.

### BACKGROUND

Users of computerized user devices (e.g., e.g., personal computers, laptop computers, tablets, smart phones, etc.) may be concerned about the security and privacy of the items they view on their user device screens when they are in a public setting. For example, office workers viewing personal, private, or confidential information on their computer screens may be concerned about colleagues or visitors viewing the items appearing on their computer screens. Similarly, users of mobile user devices (e.g., mobile phones, tablets, etc.) may be concerned about others viewing the items on their screen when they use their devices in a public setting.

Presently, various techniques for improving security and privacy of items appearing on the screen of a user device are available. For example, privacy can be provided by limiting/restricting the viewing angle through which the display screen can be viewed. The limited viewing angle only allows the users who are positioned within the viewing angle to view the items appearing on the display screen and prevents those who are positioned outside of the limited viewing angle from viewing the items on the display screen. In practice, limiting of the viewing angle can be done using various methods. For example, a polarizing filter that blocks light emitted from angles outside of the viewing angle can be coupled with the display screen of the user device.

### SUMMARY

In one aspect, a method, computerized system, and computer program product according some embodiments described herein relates to a user having a display screen wherein the brightness or the viewing angle can be changed.

The method, computerized system, and computer program product includes obtaining, at a user device, instructions for changing at least one of a brightness or a viewing angle of a display screen of the user device and, in response to the instructions, changing at least one of the brightness or the viewing angle of the display screen by controlling a backlight emitter.

In another aspect, a user device having a display screen including a backlight emitter is featured. The user device includes a processor connected to the display screen and a controller connected to the processor. The controller can receive, from the processor, instructions for changing at least one of a brightness or a viewing angle through which the display screen can be viewed and change at least one of the brightness or the viewing angle by controlling the backlight emitter.

In yet another aspect, a user device comprising a display screen is featured. The display screen includes a backlight emitter. The backlight emitter can include a plurality of primary light emitters and a plurality of secondary light emitters. The user device also includes a processor connected to the display screen and a controller connected to the processor. The controller receives, from the processor, instructions for changing at least one of a brightness or a viewing angle through which the display screen can be viewed and changes at least one of the brightness or the viewing angle by controlling the primary and secondary light emitters.

In another aspect, a method, computerized system, or computer program product for brightness or the viewing angle of the display screen of a user device is featured. The featured method includes obtaining, at a user device, instructions for changing at least one of a brightness or a viewing angle of a display screen of the user device and in response to the instructions, changing at least one of the brightness or the viewing angle of the display screen by controlling intensity of light emitted by the display screen.

In other examples, any of the above aspects, or any system, method, apparatus, and computer program product method described herein, can include one or more of the following features.

The instructions for changing at least one of the brightness or the viewing angle can be obtained from a user who interacts with the user device through an interface connected to the processor. The interface can include at least one of a graphical user interface, a button, knob, switch, scroll wheel, keyboard, mouse, touchpad, or a hotkey. Alternatively or additionally, the instructions can be obtained from an interface arranged to obtain information from surroundings of the user device. The processor of the user device can process the information obtained by the interface to determine whether to change at least one of the brightness or the viewing angle.

The brightness or the viewing angle of the display screen can be changed by increasing or decreasing at least one of the brightness or the viewing angle. Both of the viewing angle and brightness of the display screen can be reduced in response to instructions for reducing the brightness from being at a high level or an average level of brightness to being at a low level of brightness. Similarly, both viewing angle and the brightness of the display screen can be reduced in response to instructions for limiting the viewing angle through which the display screen can be viewed. Both the viewing angle and the brightness of the display screen can be increased in response to instructions for increasing the brightness from being at a low level to being at a high level or an average level of brightness. Similarly, both of the viewing angle and the brightness of the display screen can be increased in response to instructions for widening the viewing angle through which the display screen can be viewed.

The brightness or viewing angle of the display screen can be changed among various predetermined viewing modes. The predetermined viewing modes can include at least one of a viewing mode for viewing the display with a high level of brightness, a viewing mode for viewing the display with a low level of brightness, a viewing mode for viewing the display with an average level of brightness, or a viewing mode for viewing the display through limited viewing angles. The brightness and viewing angle of the display screen can be changed to being in both the low level of brightness mode and the limited viewing angle mode in response to instructions to change the viewing mode from a high level of brightness or an average level of brightness to at least one of the low level of brightness mode or the limited viewing angle mode.

The primary light emitters can be positioned at a central portion of the display screen and the secondary light emitters can be positioned at side portions of the display screen.

The controller can reduce at least one of the brightness or the viewing angle by at least one of: increasing intensity of light emitted by the primary light emitters or reducing intensity of light emitted by the secondary light emitters. The controller can increase at least one of the brightness or the viewing angle by at least one of: changing intensity of light emitted by the primary light emitters or increasing intensity of light emitted by the secondary light emitters.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a high-level block diagram of a user device that can be used as an apparatus for or include the system for dynamically controlling privacy of the display screen of the user device.

FIG. 2A is an example of an intensity spectrum for light emitting diodes (LEDs) of a display screen that are activated when the display screen is in a wide viewing mode.

FIG. 2B is an example of a viewing angle that can be made available to a user of a display screen when the display screen is in a wide viewing mode.

FIG. 2C is an example of an intensity spectrum for LEDs of a display screen that are activated when the display screen is in a private viewing mode.

FIG. 2D is an example of a viewing angle that can be made available to a user of a display screen when the display screen is in a private viewing mode.

FIG. 3A is an example of LED light intensity of the LEDs used in a backlight emitter while a display screen is a normal viewing mode.

FIG. 3B is an example of LED light intensity of the LEDs used in a backlight emitter while a display screen is a bright or sunlight viewing mode.

FIG. 3C is an example of LED light intensity of the LEDs used in a backlight emitter while a display screen is a power saving viewing mode.

FIG. 3D is an example of LED light intensity of the LEDs used in a backlight emitter while a display screen is a private viewing mode.

FIG. 4 is an example of an interface that a user can employ for adjusting the brightness and/or privacy of the display screen.

FIG. 5 is another example of an interface that the user can employ for adjusting the brightness and privacy of the display screen.

FIG. 6 is an example of a system architecture that can be used in a user device to integrate the display brightness and privacy (viewing angle) control features.

FIG. 7 is an example of various display modes among which the display of a user device described herein can transition.

### DETAILED DESCRIPTION

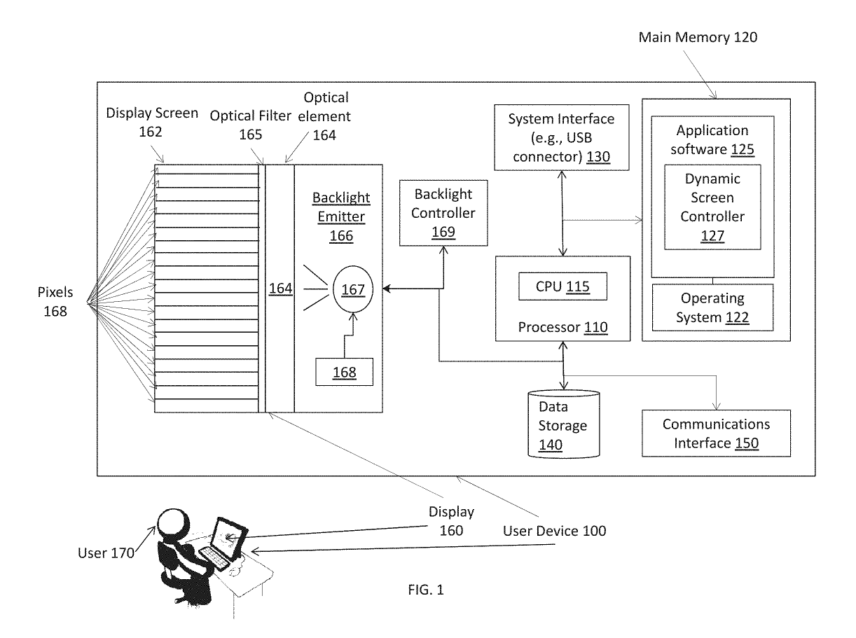

FIG. 1 is a high-level block diagram of a user device 100 that can be used as an apparatus for, or include the system or computer implemented program for, dynamically controlling privacy or brightness of the display screen 162 of the user device 100. The user device 100 can include various digital electronic circuitry or computer hardware that can be used with the embodiments disclosed herein, for example the digital circuitry associated with a desktop or laptop computer.

As shown in FIG. 1, the user device 100 can include a main memory unit 120 having an operating system 122. The main memory 120 and the operating system 122 can be configured to implement various operating system functions. For example, the operating system 122 can be responsible for controlling access to various devices, implementing various functions of the user device 100, and/or memory management. The main memory 120 can also hold application software 125. Specifically, the main memory 120 and application software 125 can include various computer executable instructions, application software, and data structures such as computer executable instructions and data structures that implement various aspects of the embodiments described herein. For example, the application software 125 can include various computer executable instructions, application software, and data structures such as computer executable instructions and data structures that implement the dynamic screen controller 127 described herein.

The techniques described herein, without limitation, can be implemented in digital electronic circuitry or in computer hardware that executes software, firmware, or combinations thereof. The implementation can be as a computer program product, for example a computer program tangibly embodied in a non-transitory machine-readable storage device, for execution by, or to control the operation of, data processing apparatus, for example a computer, a programmable processor, or multiple computers.

Further, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network.

One or more programmable processors can execute a computer program to operate on input data, perform function and methods described herein, and/or generate output data. An apparatus can be implemented as, and method steps can also be performed by, special purpose logic circuitry, such as a field programmable gate array (FPGA) or an application specific integrated circuit (ASIC). Modules can refer to portions of the computer program and/or the processor or special circuitry that implements that functionality.

The main memory 120 can be any form of non-volatile memory included in machine-readable storage devices suitable for embodying data and computer program instructions. For example, the main memory 120 can be magnetic disk (e.g., internal or removable disks), magneto-optical disks, one or more of a semiconductor memory device (e.g., EPROM or EEPROM), flash memory, CD-ROM, and/or DVD-ROM disks. The main memory 120 can be connected to a processor 110 and, possibly, a cache unit (not shown) configured to store copies of the data from the most frequently used main memory 120. The processor 110 and the main memory 120 can be included in or supplemented by special purpose logic circuitry.

The processor 110 can include a central processing unit 115 that includes processing circuitry configured to manipulate data structures from the main memory 120 and execute various instructions. For example, the processor 110 can be a general and/or special purpose microprocessor and any one or more processors of any kind of digital computer. Generally, the processor 110 can be configured to receive instructions and data from the main memory 120 (e.g., a read-only memory or a random access memory or both) and execute the instructions. The instructions and other data can be stored in the main memory 120.

The processor 110 can also be connected to various interfaces via a system interface 130, which can be an input/output (I/O) device interface (e.g., USB connector, audio interface, FireWire, interface for connecting peripheral devices, etc.). The processor 110 can also be connected a communications interface 150. The communications interface 150 can provide the user device 100 with a connection to a communications network (not shown). Transmission and reception of data, information, and instructions can occur over the communications network. The processor 110 can also be coupled to one or more data storage elements 140 and be arranged to transfer data to and/or receive data from the data storage elements 140.

The user device 100 can also include a display 160 for receiving and/or displaying information (e.g., monitor, display screen, etc.). The display 160 can be a touch-sensitive display and/or any type of display known in the art. The display 160 can generally include a backlight emitter 166 (“backlight”) that emits light rays (shown as lines extending out of light source 167 towards the optical element 164) that are directed by an optical element 164 to a display screen 162.

The display screen 162 can be a liquid crystal display (LCD), a light emitting diode (LED) display, or any other type of display known in the art. The display screen 162 can include multiple pixels 168 arranged in a matrix. The pixels 168 can have any properties possessed by display screen pixels known in the art. For example, the pixels 168 can be configured such that each pixel is capable of receiving, controlling, directing, and/or modulating light beams forwarded from the backlight emitter 166. Similarly, the pixels 168 can be configured such that each pixel is capable of receiving, controlling, directing, and/or modulating light in the environment surrounding the user device 100.

The optical element 164 can include one or more reflective or refractive elements that are configured to distribute, direct, reflect, or scatter the light forwarded by the backlight emitter 166 to ensure that the forwarded light is distributed uniformly across the display screen 162. The optical element 164 can include a substrate having reflective or transmissive capabilities, can be controlled to amplify, modulate, reduce, and/or block the light rays forwarded by the backlight emitter 166 before the light rays can reach the display screen 162. For example, the optical element 164 can include two or more transparent electrode substrates (not shown) that are separated using a type of liquid crystal (not shown). The liquid crystal can direct, transmit, or scatter the light emitted by the backlight emitter 166. The electrodes can also be used to control the scattering and/or transmission of the light rays by the liquid crystal.

The optical element 164 can further be configured to control the viewing angle for the display screen 162 and/or the intensity and brightness of the display screen. The optical element 164 can control the viewing angle and intensity of the display independently or in conjunction with or in addition to the functions provided by other portions of the display 160, such as the backlight emitter 166.

For example, the optical element 164 can include an optical filter 165 configured to control the viewing angle for the display screen 162. The optical filter 165 can be used to control, decrease, or limit the viewing angle of the display screen 162. By controlling the viewing angle of the display screen 162, the optical filter 165 can limit the angles through which the display screen 162 can be viewed, thereby preventing those outside of the viewing area from viewing the items appearing on the display screen. The optical filter 165 can be a configurable, controllable, and/or switchable filter that can be configured to allow changes to the viewing angle of the display screen 162.

For example, the optical filter 165 can have Fresnel mirrors to control optical direction depending on which area of backlight is emitted. When the light source at the horizontal center of backlight emitter is lit, the light proceeds straight horizontally and the user 170 can see the light when she is facing the display Screen 162 at the horizontal center. When light source 167 is at the horizontal right, the light proceeds leftward and the user 170 can see the light when she is facing the display screen 162 at the horizontally left. When the light source is 167 is at the horizontal left, the light proceeds rightward and the user 170 can see the light when she is facing the display screen 162 at the horizontal right. Therefore, when the light source is wide spread, the viewing angle can be wide. When the light source is only at the horizontal center, the viewing angle can be narrow.

In addition to controlling the viewing angle, the optical filter 165 can also control the brightness and/or intensity of the display screen 162. The optical filter 165 can control the brightness, intensity, and/or the viewing angle of the display 162 independently and/or in conjunction with other components of the display screen, such as the backlight emitter 166.

The backlight emitter 166 facilitates viewing of the items appearing on the display screen 162, for example under low-light conditions. Although backlight emitters 166 are typically used for LCD display screens, embodiments disclosed herein are not limited for use with LCD display screens and can be used with any display screen that employs a backlight emitter.

The backlight emitter 166 can be any backlight known in the art. Generally, the backlight 166 can include a light source 167 and a light source controller 168 that controls the activation of the light source 167. The light source 167 can include a number of light emitting diodes (LEDs) and/or include any type of light emitting source/lamp known in the art. For example, the light source 167 can include one or more fluorescent, incandescent, or electroluminescent lamps and/or any other suitable light source known in the art.

The backlight emitter 166 can be controllable using a backlight controller 169 that controls the brightness and/or intensity of light emitted by the light source 167 and/or the amount of light provided by the backlight emitter 169 to the optical element 164. The backlight controller 169 can also control the viewing angle through which the display screen 162 can be viewed by controlling the backlight emitter 166. For example, the backlight controller 169 can control the intensity and/or brightness of the light emitted by the backlight emitter 166 and/or the viewing angle through which the display screen 162 can be viewed by activating a select number of LEDs included in the light source 167 and/or by controlling the activation cycle of the light source 167.

By controlling the backlight emitter 166, the user device 100 can control the brightness or intensity of the display screen 162. Any method known in the art for controlling the brightness and/or intensity of the display screen 162 using the backlight emitter 166 can be used. For example, the brightness and/or intensity of the display screen 162 can be controlled by adjusting the electrical power supplied to the backlight emitter 166. Additionally/alternatively, the brightness and/or intensity of the display screen 162 can be controlled by adjusting the voltage and/or electrical supplied to the optical element 164 and/or controlling the amount of light scattered/directed through the optical filter 164.

The brightness of the display 162 can be adjusted automatically by the user device 100 in response to detection of the light levels (e.g., ambient light) in the environment in which the user device 100 is being used and/or in response to a request from the user 170. For example, the brightness and/or the intensity of the backlight emitter 166 and/or the display screen 162 can be controlled in response to receiving instructions from the user when the user interacts with the user device 100. The user 170 can interact with the user device 100 through buttons, knobs, switches, scroll wheels, keyboard, mouse, touchpad, etc. that are connected to the processor 110 (e.g., these elements can be coupled to the processor through the system interface 130). Alternatively or additionally, the user 170 can interact with the user device 100 using a graphical user interface (GUI) displayed on the screen of the user device 100. The GUI can receive the user's instructions and forward the instructions to the processor 110, thereby indicating to the processor 110 that the user wishes to adjust the intensity or brightness of the display screen 162.

As noted, the backlight emitter 166 can also control, or contribute to control, of the viewing angle of the display screen 162. For example, the light emitted from the backlight emitter 166 can be controlled and directed such that only certain viewing angles are enabled. As noted previously, any backlight emitter, such as a conventional backlight emitter and/or an intelligent backlight emitter, and/or any privacy filter known in the art can be used with the embodiments described herein.

The user 170 can be allowed to control and operate the user device 100 in various viewing modes. Specifically, although the user 170 can generally be allowed to change the brightness of the display screen to any desired level, the user device 100 may provide the user 170 with various viewing modes, each having a pre-assigned screen brightness level. For example, the user device 100 can have a setting for operating the device 100 in a high background light environment (e.g., sunlight), a setting for operating the device 100 in a generally normally lit environment (e.g., in-doors in a normally/averagely lit room, daytime, average lighting), a setting for operating the device in a low background light environment (e.g., night time, power saving), etc. The user device 100 can also switch among these predetermined modes automatically (e.g., in response to detecting ambient/environment light levels in which the device 100 is being used).

Similarly, the user 170 can be allowed to change the privacy and/or viewing angle of the display screen 162. Additionally or alternatively, the user can be provided with one or more private viewing modes and be allowed to switch between a normal viewing mode and a private viewing mode. While in normal viewing mode, the display screen 162 can be viewed through normal (e.g., wide) viewing angles. While in private viewing mode, the display screen 162 can be viewed through limited viewing angles.

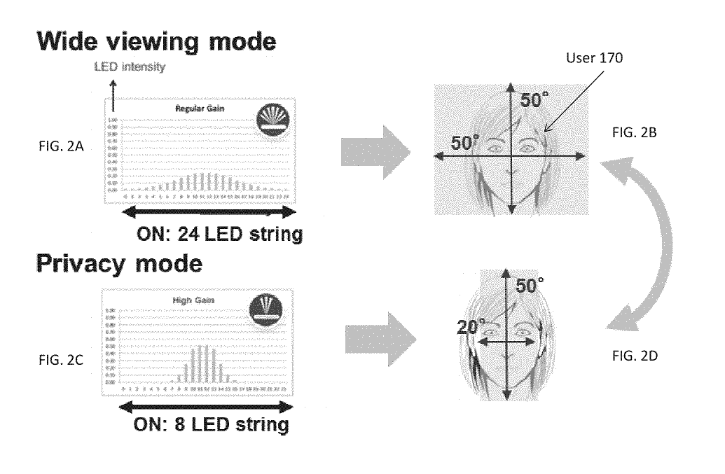

FIG. 2A is an example of the intensity or gain spectrum for LEDs of a display unit 160 that are activated when the display screen is in a wide viewing mode. As mentioned above, the viewing angle can be controlled by selectively changing the intensity of the light source 167. Specifically, FIG. 2A demonstrates the intensities of the light generated by a 24-LED string when the display screen is in a wide viewing mode. FIG. 2B is an example of the viewing angle that can be made available to the user 170 when the display 160 is in a wide viewing mode. As shown in FIG. 2B, while in wide viewing mode, the user 170 can view the screen through a wide range of angles when the display 160 is in the wide viewing angle mode. In the example shown in FIG. 2B, the horizontal viewing angle is controlled and vertical viewing angle is kept same. The vertical viewing angle can also be controlled in a similar fashion. The 50° angle signs denote example viewing angles that can be used to allow the user to view the screen through a wide range of angles.

FIG. 2C is an example of the intensity or gain spectrum for LEDs of a display unit 160 that are activated when the display screen is in a private viewing mode. Specifically, FIG. 2C demonstrates the intensities of the light generated by a 8-LED string when the display screen is in a private viewing mode. As shown in FIG. 2C, while in the private mode, the active LED's operate at a higher gain than they do while the display is in the wide viewing mode (shown in FIG. 2A) for central portions of the display screen 162, and at a lower gain (intensity, amplifications or other measures of energy emitted by the LED) for side portions. In the examples shown as FIG. 2A and FIG. 2C, while in the private mode, the active LEDs (LEDs located at position 9 to the position 14) are operated at a higher gain than they are operated while the display is in the wide viewing mode. The remaining LEDs (LEDs located at position 0 to the position 8 and from the position 15 to the position 23) are operated at a lower gain than they are operated while the display is in the wide viewing mode. FIG. 2D is an example of the viewing angle that can be made available to the user 170 when the display 160 is in a private viewing mode. As shown in FIG. 2D, while in private viewing mode, the user 170 has a limited range of angles through which she can view the display screen 160.

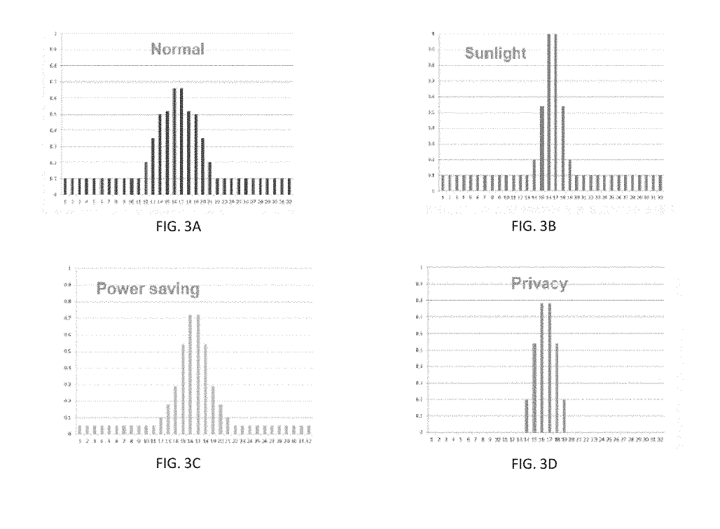

FIG. 3A is an example of LED light intensity of the LEDs used in the backlight emitter 166 while the display screen 160 is the normal viewing mode. As shown in FIG. 3A, while in the normal viewing mode, all LEDs are activated, although operating at different intensity levels. Specifically, the LEDs that provide the backlight for the central portions of the viewing angle, where a user would typically be located, are operating at higher intensities than the LEDs that provide the backlight for the side portions of the viewing angle. Similarly, as shown in FIG. 3B, while in the bright/sunlight viewing mode, all LEDs are activated with certain LEDs that provide the backlight for the central portions of the viewing angle operating at higher intensities than they did while the display was in the normal operating mode.

FIG. 3C is an example of LED light intensity of the LEDs used in the backlight emitter 166 while the display screen 160 is the power saving mode. As shown in FIG. 3C, while in normal viewing mode, all LEDs are activated but the LEDs that provide the backlight for the side portions of the viewing angle are operating at lower intensities than when the display is in the normal (FIG. 3A) and Sunlight (FIG. 3B) modes.

However, as shown in FIG. 3D, while the display device 160 is in the privacy mode, only the LEDs that provide the backlight for the central portions of the viewing angle are activated. These LEDs are operating at higher intensity levels than they did when the display 160 was the normal (FIG. 3A), sunlight (FIG. 3B), and power saving (FIG. 3C) modes.

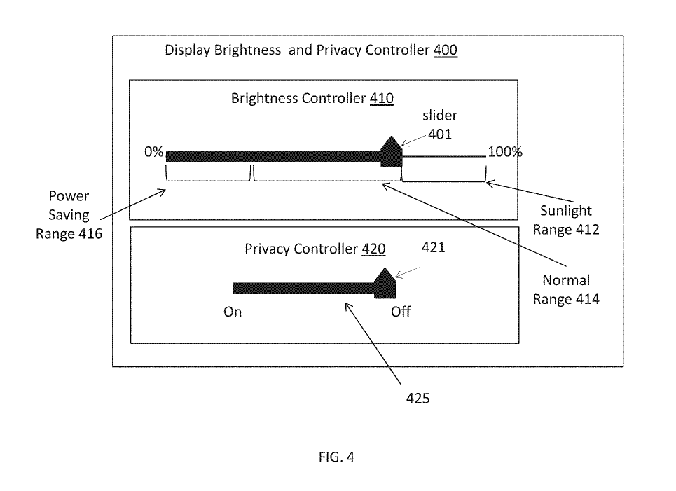

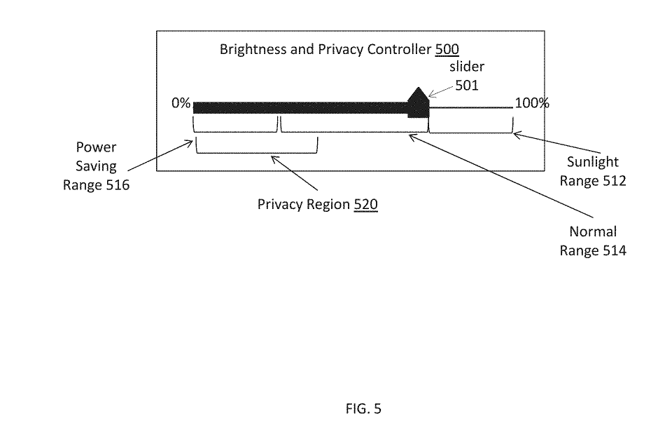

As noted, the user 170 can control both the brightness and the privacy of the display screen 162. FIG. 4 is an example of an interface 400 that the user 170 can employ for adjusting the brightness and/or privacy of the display screen. Although the example shown in FIG. 4 utilizes two separate scroll tabs for adjusting/controlling brightness and privacy of the display 162, the brightness and privacy of the display screen can be controlled using a single feature (as shown in FIG. 5). Specifically, the user device 100 can allow the user 170 to utilize the same feature (e.g., button, knob, switch, scroll wheel, keyboard shortcut, mouse, touchpad, etc.) to control and adjust both the brightness and privacy of the display screen 162.

Referring to FIG. 4, the interface for controlling display brightness and privacy 400 can include a brightness controller 410 and a privacy controller 420. The brightness controller 410 can include a feature (e.g., slider 401) that can be used by the user for adjusting the brightness of the display screen 162. For example, the user can use the slider 401 to change the brightness of the display screen 162 from 0% brightness (i.e., minimum brightness, for example a completely dark screen) to 100% brightness (i.e., maximum brightness). Further, as shown in FIG. 4, the user can adjust the brightness of the display screen and move the brightness between various brightness modes. For example, the user can adjust the brightness of the display such that the brightness level falls within a sunlight viewing mode (e.g., brightness spectrum shown in FIG. 3B), a normal viewing mode (e.g., brightness spectrum shown in FIG. 3A), or a power saving viewing mode (e.g., brightness spectrum shown in FIG. 3C).

Further, as shown in FIG. 4, for each viewing mode (e.g., sunlight, normal, or power saving), the user device 100 can provide the user with a range of brightness levels over which the display can be in that viewing mode. For example, the display 162 can be in the sunlight-viewing mode when the brightness level is within a sunlight brightness range 412, in the normal viewing mode when the brightness level is within a normal brightness range 414, or in the power saving viewing mode when the brightness level is within the power saving brightness range 416.

Similarly, the privacy controller 420 can provide the user with the option of switching the display to a private viewing mode. For example, as shown in FIG. 4, the display brightness and privacy controller 400 can have a feature (e.g., slider 421) that can be used to switch the privacy viewing feature between an on or off position.

As noted, the user device 100 can integrate the brightness and privacy controller (e.g., brightness controller 410 and privacy controller 420 shown in FIG. 4) such that they are controlled and/or included in the same feature. Presently available user devices do not have the capability for managing both the brightness and viewing angle of the display screen. By integrating the brightness and viewing angle control features, embodiments disclosed herein allow the user device to manage both the brightness and viewing angle of the user device. The user device can control the brightness and viewing angle by adjusting the light emitted by the backlight. Specifically, as described below, in some implementations, the display and brightness can be controlled such that once the device is placed in a power saving (e.g., low brightness) mode, the viewing angle is also reduced to place the device in a private mode. Similarly, the user device can transition into the power saving mode upon being placed in the privacy mode.

The transition into or out of the power saving mode can occur upon receiving a request from the user and/or automatically upon detection of a certain predetermined condition by the device (e.g., detection of low ambient light for transition into the power saving mode and detection of high ambient light for transition out of the power saving mode or transitioning into the power saving mode when the device is operated on battery or transitioning out of the power saving mode when the device is connected to an electrical outlet). Similarly, the transition into or out of the privacy mode can occur in response to receiving a request from the user and/or automatically upon detection of a certain predetermined condition by the device (e.g., transitioning into private mode in response to the device determining that it is placed in a public environment).

FIG. 5 is an example of an interface 500 that the user 170 can employ for adjusting the brightness and privacy of the display screen. As shown in FIG. 5, the interface for controlling display brightness and privacy 500 can include a feature (e.g., slider 501) that can be used by the user for adjusting both the brightness and privacy of the display screen 162. For example, the user can use the slider 501 to switch the brightness of the display screen 162 among the sunlight mode (or sunlight region 512), the normal mode (or normal region 514), and/or power saving mode (or power saving region 516). The brightness and privacy controller can also have a predetermined brightness region 520 over which the display screen can enter the privacy mode (e.g., provide the user with limited viewing angle on the display screen 162). For example, as shown in FIG. 5, the display screen can be arranged such that it enters the privacy mode when the brightness of the display screen falls within the power saving range 516 and/or within certain portions of the normal viewing range 514.

By integrating the brightness and privacy controller features, the brightness and privacy controller 500 shown in FIG. 5 allows the user to control both the brightness of the display screen and the privacy of the display screen simultaneously. By integrate the display brightness control and dynamic viewing angle control features (i.e., privacy control features), the user device 100 allows the display brightness level to specify the amount of brightness that she wishes the screen to have. For example, if the user decides to use the maximum value of brightness (100%), the brightness of the screen is boosted and the screen is placed in the sunlight mode. Similarly, if the user decides to use a medium to high level of brightness for the screen, the screen is placed in the normal mode. Also, if the user decides to use a lower brightness level for her screen (e.g., power saving range 516), the screen adjusts accordingly by lowering the brightness of the display. Additionally, if the user decides to place the display screen in the power saving mode and/or within certain predetermined areas in the normal range, the user device 100 can adjust the screen such that the device is placed in the limited viewing angle mode (or the privacy mode). While in the privacy region, the screen 162 can only be viewed through certain viewing angles.

By integrating the brightness and privacy controller features, embodiments described herein allow the user to simply use the built-in brightness controller of the user device 100 to simultaneously control the brightness of the screen and control the viewing angle/privacy of the screen. In this way, the user has the ability to both place the display screen of her user device in the privacy mode and control the brightness of the display screen while the device is in the privacy mode. For example, the user can make the screen brighter or darker and continue to remain in the privacy mode, as long as the adjustments to the brightness of the display screen fall within the brightness levels included in the privacy region 520.

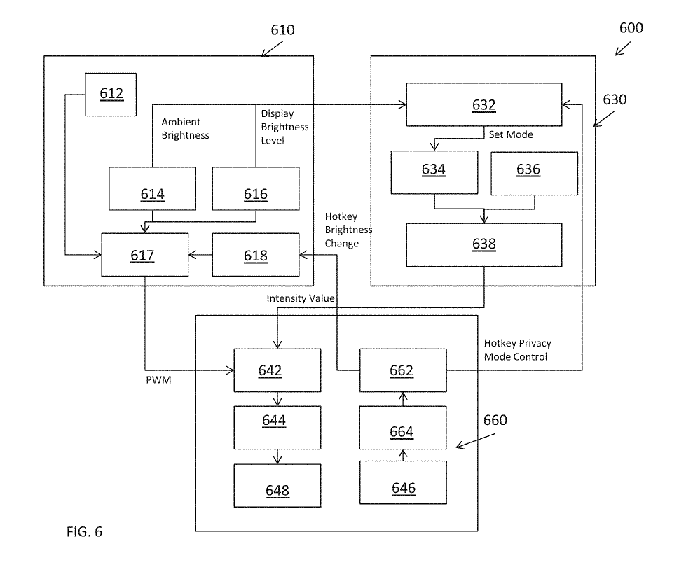

FIG. 6 is an example of a system architecture that can be used in a user device to integrate the display brightness and privacy (viewing angle) control features. The system architecture 600 can include components used to control and manage the display screen (display components 610), components related to control and management of application software responsible for control of the display (control software 630), components and hardware 660 related to control and management of the brightness, privacy, and viewing angle of the display screen.

The display components 610 can include the display user interface 612 that provides the user device with the capability to forward and receive information and data. For example, the interface 612 can include a touchpad that can be used to receive information from the user and/or display pixels that can receive and/or transmit information. For example, the pixels can receive information about the level of ambient light in the surroundings of the user device and forward that information to the user device. Additionally or alternatively, the pixels can provide the user device with the required information for detecting the number of people disposed in the environment surrounding the user device. The user device can use this information to determine whether to switch the device to a narrow viewing angle or private mode.

The display components 610 can also include an adaptive learning system (ALS) 614 that processes the information received from the user interface 612 (e.g., information regarding ambient brightness and forwards that information to the control software 630). The display components can also include a power manager 616 that handles the required tasks for managing and controlling the brightness of the display screen. For example, the power manager 616 can monitor, manage, and control the brightness of the control screen and report the information regarding the brightness of the display screen to the control software 630.

The display components 610 can also include a display driver model 617 (e.g., a windows display driver model (WDDM)). The display driver model 617 can provide the functionality required for displaying the desktop of the user device and any applications running on the user device. The display driver model 617 can also provide the interfaces for the applications running on the user device. The display driver model 617 can also forward information, such as Pulse Width Modulated (PWM) video signals to microcontrollers (MCU) 642 included in the hardware components 660.

The display components 610 can also include a human input (or interface) device (HID) 618. The human interface device 618 can directly interact with the user to receive inputs from the user and communicate any outputs to the user. The human interface device 618 can be connected to an advanced configuration and power interface (ACPI) for operating a basic input and output system (BIOS) 662. The BIOS is responsible for hardware initiation during the startup (booting) process, and the ACPI provides the required standards that the operating system of the user device can use for tasks such as power management, hardware discovery, configuration, monitoring, etc. The HID 618 can receive information regarding changes to brightness of the display screen from the ACPI BIOS 662. The information can be input hotkeys (e.g., a key or combination of keys used together as a shortcut for requesting performance of a certain task form the user device). For example, information input through keyboard hotkeys for changing the brightness of the display screen can be forwarded from the ACPI BIOS 662 to the HID 618.

The control software 630 can include a user interface 632 that can be used by the user to directly interact with the applications on the user device. The user interface 632 can be arranged to receive information regarding the ambient light brightness and display brightness level from the ALS 614 and windows power manager 616, respectively.

The user interface 632 can forward information, including information needed to set the brightness of the display screen (e.g., normal mode, bright mode, or power saving mode) to an Application Programming Interface (API) controller 634 that is responsible for receiving and forwarding information from the user interface 632 to a device driver 638. The device driver 638 is responsible for controlling or operating the components attached to the user device, for example the display screen. As shown in FIG. 6, the device driver 638 can forward the values for brightness and intensity of the display screen to the MCU 642.

The ACPI BIOS 662 component included in the hardware component 660 can receive information indicating user's preference for the privacy (i.e., viewing angle) and brightness (e.g., sunlight, normal, or power saving modes) of the display screen through the embedded controller 664 and the hotkey 666. Specifically, the user can use a hotkey shortcut (or any other method known in the art) to indicate that she wishes to view the display screen with a certain brightness level (e.g., in the normal mode or in the power saving mode). The display brightness level can indicate the level of privacy for the screen. For example, if the display is being viewed in the sunlight or normal mode, the display is not placed in the limited angle or privacy mode. However, if the display is being viewed in the power saving mode (or within certain regions of the normal viewing mode), the display is also placed in the limited angle or private mode.

Alternatively and/or additionally, the user can indicate her preference for private viewing to the user device and the user's preference with respect to privacy can be used to indicate the level of brightness of the screen. Specifically, if the user uses a hotkey to indicate that she wishes to view the screen in the private or limited angle mode, the display brightness can change accordingly to be within the power saving range (or certain regions of the normal viewing mode). If the user indicates that she wishes to view the display screen through a wide viewing angle, the display brightness can be changed accordingly and placed in a higher brightness level (e.g., normal or sunlight viewing).

The information received by the hotkey 666 is forwarded to the ACPI BIOS 662 through the embedded controller 664. The ACPI BIOS 662 forwards the information regarding the viewing angle (e.g., whether the user wishes to view the display screen in a private, limited angle mode) to the user interface 632 for the control software. The ACPI BIOS 662 also forwards the information regarding changes to the brightness of the display screen (e.g., changes to the level of brightness such as a change to a low-power mode when viewing in the private mode) to the HID 618. As shown in FIG. 6, this information is forwarded to the WDDM driver 617. The WDDM driver 617 connects to the MCU 642 and forwards the information to components 644 included in the display of the user device for use in controlling the LEDS included in the backlight 646.

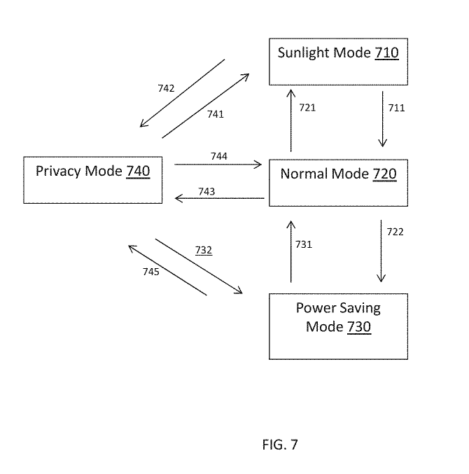

FIG. 7 is an example of various display modes among which the display of a user device described herein can transition. As shown in FIG. 7, the display of the user device can transition 711 from a sunlight mode 710 to a normal mode 720 by decreasing the brightness of the screen. Similarly, the display screen can transition 722 from the normal mode 720 to the power saving mode 730 by decreasing the brightness of the screen. Once the display screen has transitioned to the power saving mode 722, it can also transition 745 into the privacy mode 740 by decreasing the viewing angle of the monitor. As noted, by integration of display brightness and privacy control features, the display screen can transition 745 to the privacy mode 740 upon being placed in the power saving mode 730. The user device can complete this transition 745 by reducing the viewing angle of the display screen.

The transition 743 to the privacy mode can also occur while the display screen is in the normal mode 720. As noted, by integration of display brightness and privacy control features, the display screen can transition 732 to the power saving mode 730 upon being placed in the privacy mode 740.

Similarly, the display device can transition 741 from the privacy mode 740 to the sunlight mode 710. To complete this transition, the user device increases the viewing angle and the brightness of the display screen. Similarly, the display device can transition 742 from the sunlight mode 710 to the privacy mode 740 by reducing the viewing angle (transition 742 to privacy mode 740) and brightness (transition 732 to power saving mode 730) of the display screen.

The display screen can also transition out 731 of the power saving mode 730 to the normal mode 720 by increasing the brightness of the display screen. Similarly, the display can transition 721 out of the normal mode 720 to the sunlight mode 710 by increasing the brightness of the display screen.

While the invention has been particularly shown and described with reference to specific illustrative embodiments, it should be understood that various changes in form and detail may be made without departing from the spirit and scope of the invention.

1. A user device comprising:
a display screen including a backlight emitter;
a processor connected to the display screen; and
a controller connected to the processor, the controller being configured to receive, from the processor, instructions for changing at least one of a brightness or a viewing angle through which the display screen can be viewed and change at least one of the brightness or the viewing angle by controlling intensity of light generated by the backlight emitter.

2. The user device of claim 1 wherein the processor is configured to obtain the instructions for changing at least one of the brightness or the viewing angle from a user who interacts with the user device through an interface connected to the processor.

3. The user device of claim 1 wherein the processor is configured to obtain the instructions for changing at least one of the brightness or the viewing angle from an interface arranged to obtain information from surroundings of the user device, the processor being arranged to process the information obtained by the interface to determine whether to change at least one of the brightness or the viewing angle.

4. The user device of claim 1 wherein the controller is configured to reduce both the viewing angle and the brightness of the display screen in response to instruction for limiting the viewing angle through which the display screen can be viewed.

5. The user device of claim 1 wherein the controller is configured to increase both the viewing angle and the brightness of the display screen in response to instruction for widening the viewing angle through which the display screen can be viewed.

6. The user device of claim 1 wherein the controller is arranged to change the brightness or viewing angle of the display screen among various predetermined viewing modes.

7. The user device of claim 6 wherein the predetermined viewing modes include at least one of a viewing mode for viewing the display with a high level of brightness, a viewing mode for viewing the display with a low level of brightness, a viewing mode for viewing the display with an average level of brightness, or a viewing mode for viewing the display through limited viewing angles.

8. The user device of claim 7 wherein the controller is configured to change the brightness and viewing angle of the display screen to being in both the low level of brightness mode and the limited viewing angle mode in response to instructions instructing to change the viewing mode from a high level of brightness or an average level of brightness to at least one of the low level of brightness mode or the limited viewing angle mode.

9. A method comprising:
at a user device:
obtaining instructions for changing at least one of a brightness or a viewing angle of a display screen of the user device; and
in response to the instructions, changing at least one of the brightness or the viewing angle of the display screen by controlling intensity of light generated by a backlight emitter.

10. The method of claim 9 further including obtaining the instructions for changing at least one of the brightness or the viewing angle from a user who interacts with the user device through an interface connected to a processor of the user device.

11. A user device comprising:
a display screen including a backlight emitter, the backlight emitter including a plurality of primary light emitters and a plurality of secondary light emitters;
a processor connected to the display screen; and
a controller connected to the processor, the controller being configured to receive, from the processor, instructions for changing at least one of a brightness or a viewing angle through which the display screen can be viewed and change at least one of the brightness or the viewing angle by controlling intensity of light emitted by the primary and secondary light emitters.

12. The user device of claim 11 wherein the primary light emitters are positioned at a central portion of the display screen and the secondary light emitters are positioned at side portions of the display screen.

13. The user device of claim 11 wherein the controller is configured to reduce at least one of the brightness or the viewing angle by at least one of: increasing the intensity of light emitted by the primary light emitters or reducing the intensity of light emitted by the secondary light emitters.

14. The user device of claim 11 wherein the controller is configured to increase at least one of the brightness or the viewing angle by at least one of: changing the intensity of light emitted by the primary light emitters or increasing the intensity of light emitted by the secondary light emitters.

15. A method comprising:
at a user device:
obtaining instructions for changing at least one of a brightness or a viewing angle of a display screen of the user device; and
in response to the instructions, changing at least one of the brightness or the viewing angle of the display screen by controlling intensity of light emitted by the display screen.

16. The method of claim 15 further including reducing at least one of the brightness or the viewing angle of the display screen by at least one of: increasing intensity of light emitted by light emitters positioned at a central portion of the display screen or decreasing intensity of light emitted by light emitters positioned at side portions of the display screen.

17. The method of claim 15 further including increasing at least one of the brightness or the viewing angle of the display screen by at least one of: changing intensity of light emitted by light emitters positioned at a central portion of the display screen or increasing intensity of light emitted by light emitters positioned at side portions of the display screen.
